(19) United States
(12) Patent Application Publication
(10) Pub. No.: US 2007/0007085 A1
(43) Pub. Date: Jan. 11, 2007

(54) Elevator escape device with improved ventilation system

(76) Inventor: Chiu Nan Wang, Taichung Hsien (TW)

Correspondence Address: PRO-TECHTOR INTERNATIONAL SERVICES, 20775 NORADA CT., SARATOGA, CA, 95070, US

(21) Appl. No.: 11/514,048

(22) Filed: Aug. 31, 2006

Related U.S. Application Data
(62) Division of application No. 11/154,885, filed on Jun. 15, 2005.

(51) Int. Cl. B66B 5/16

(52) U.S. Cl. 187/377

(57) ABSTRACT

Provided is an elevator escape device comprising a slow movement assembly. In case of power outage a person trapped in the car can pull a rope or activate a backup generator by means of a remote control for enabling an electromagnetic actuator for closing an electromagnetic contact and disable a brake, and a sheave slowly rotates in response to a height difference between a counterweight and the car. In a ventilation system of the device in case of fire, smoke is filtered by a filter, a blower is activated to blow filtered air into the car, and the pressurized fresh air is drawn into the car.

This is a divisional application of U.S. Patent application No 11154885. filed on 2005.Jun.15

### BACKGROUND OF THE INVENTION

1. Field of Invention

The present invention relates to escape devices of elevator and more particularly to an improved manual escape device adapted to open the door of an elevator in case of emergency. The present invention still more particularly relates to such escape device with improved ventilation system.

2. Related Art

Conventionally, both a backup power supply (e.g., generator) and a normal motor are provided in an elevator such that the backup generator is able to supply power to the motor for maintaining its normal operation in case of power outage. However, the backup generator is useless if the motor is also malfunctioned, i.e., person(s) still trapped in the car. Moreover, elevator brake may malfunction while the elevator is operating. A brake disc may burn out due to a continuous rubbing by the brake. Thus, the elevator may fall to the ground in this case. Further, smoke caused by fire may blow upward along a shaft. Eventually, smoke may enter a car. Thus, person(s) trapped in the car may suffocate or even die. Typically, a manual escape device is provided in the car such that a person trapped in the car may operate the escape device to escape. However, it is often that the car may open at a position between two adjacent floors by operating the escape device in case of both power outage and the malfunctioned motor. This also cannot help person(s) trapped in the car escape safely. Thus, it is desirable to provide a novel elevator escape device in order to overcome the inadequacies of the prior art.

### SUMMARY OF THE INVENTION

It is therefore an object of the present invention to provide an escape device of an elevator comprising a car, a motor including normal coils, a sheave driven by the motor, hoist ropes run in a grooved rim of the sheave, the hoist ropes having one end connected to the car, a counterweight connected to the other end of the hoist ropes, a backup power supply for activating the motor, a brake provided between the sheave and the motor, and a slow movement assembly including a brake bar provided on a top of the brake; a fixed roller; a rope having one end fixedly connected to the brake bar and the other end extended down onto a wall of the car by running in the roller; and a pair of electromagnetic contact and electromagnetic actuator provided between the brake bar and the roller, wherein in case of power outage a person trapped in the car can pull the rope or activate the backup generator by means of a remote control for enabling the electromagnetic actuator so as to close the electromagnetic contact and disable the brake, and the sheave slowly rotates in response to a height difference between the counterweight and the car.

It is another object of the present invention to provide an escape device of an elevator having a car, the escape device comprising a ventilation system including an air inlet disposed on a roof of the car; a filter disposed in the air inlet; and a blower disposed in the air inlet, wherein in case of fire, smoke is filtered by the filter, and the blower is activated to blow filtered air into the car.

The above and other objects, features and advantages of the present invention will become apparent from the following detailed description taken with the accompanying drawings.

### BRIEF DESCRIPTION OF THE DRAWINGS

FIG. 1 is a schematic side drawing of a first preferred embodiment of escape device mounted above an elevator according to the invention;

FIGS. 2, 3, 4, and 5 are schematic side drawings of first, second, third, and fourth preferred embodiments of brake arrangement according to the invention respectively; and

FIG. 6 is a schematic sectional view of ventilation arrangement of an elevator car according to the invention.

### DETAILED DESCRIPTION OF THE INVENTION

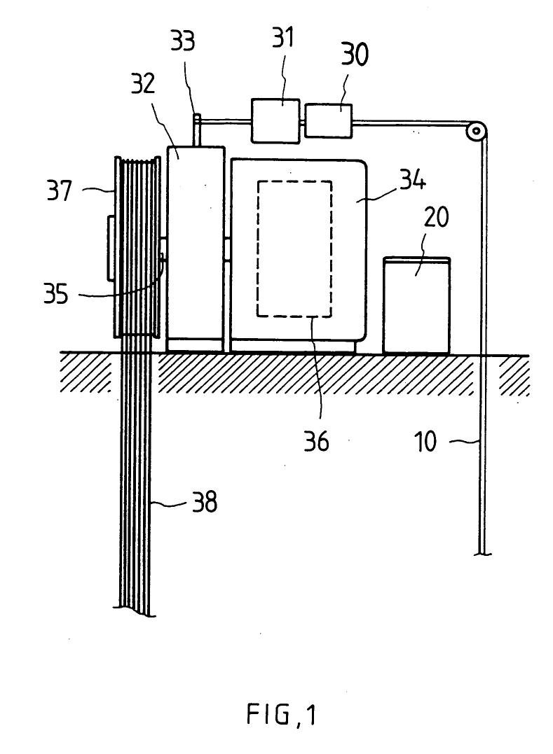

Referring to FIG. 1, a first preferred embodiment of elevator escape device according to the invention is shown. The characteristics of the first preferred embodiment are detailed below. A motor 34 comprises normal coils 36 and a drive shaft 35. A sheave 37 is provided at an outer end of the drive shaft 35. Hoist ropes 38 are run in a grooved rim of the sheave 37 and having one end connected to a car (not shown) and the other end connected to a counterweight (not shown). A brake 32 is provided between the sheave 37 and the motor 34. A slow movement assembly comprises a rope 10 having one end fixedly connected to a brake bar 33 and the other end extended down onto a wall of the car. Between the brake bar 33 and a fixed roller there are provided an electromagnetic contact 31 and an electromagnetic actuator 30. In case of power outage person(s) trapped in the car may pull the rope 10 or activate the backup generator 20 by means of a remote control for enabling the electromagnetic actuator 30. And in turn, the electromagnetic contact 31 is closed. The brake 32 is thus disabled. Thereafter, the drive shaft 35 rotates due to height difference between the counterweight and the car. The rotating speed of the drive shaft 35 is small due to the magnetic damping effect of the normal coils 36. As an end, the car is able to lower slowly

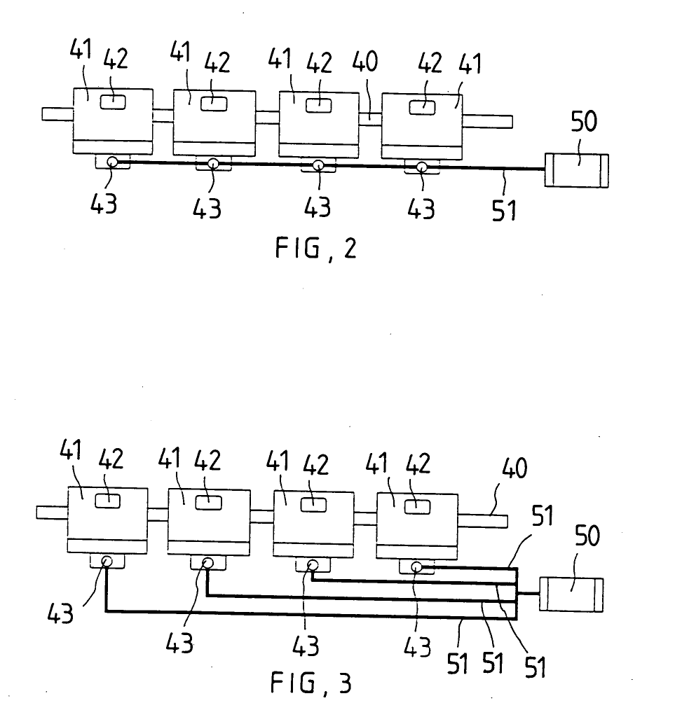

Referring to FIG. 2, a brake system according to a first preferred embodiment of the elevator escape device comprises a brake disc 40 and four brakes 41 disposed thereon, each brake 41 having a detector 42 and a brake bar 43. An auxiliary actuator 50 comprises a link 51 extended through the brake bars 43 in series. As such, any brake bar 43 (and thus the associated brake 41) can be deactivated by controlling the auxiliary actuator 50.

Referring to FIG. 3, a brake system according to a second preferred embodiment of the elevator escape device is characterized in that each of four links 51 is interconnected one of the brake bars 43 and the auxiliary actuator 50 (i.e., parallel connection). Also, any brake bar 43 and thus the associated brake 41 can be deactivated by controlling the auxiliary actuator 50.

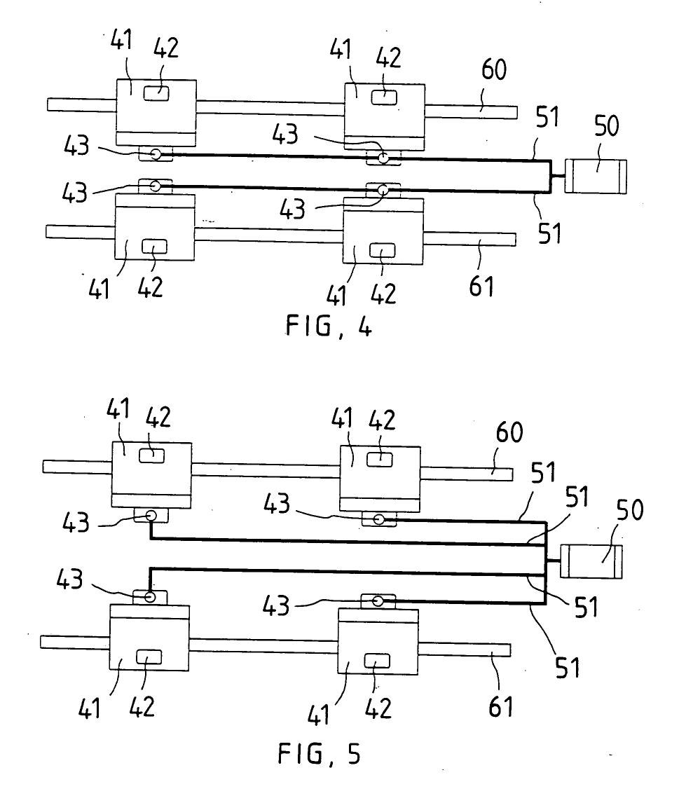

Referring to FIG. 4, a brake system according to a third preferred embodiment of the elevator escape device is characterized in that one end of one link 51 is extended through a pair of brake bars 43 in series and the other end thereof is connected to the auxiliary actuator 50, one end of the other link 51 is extended through another pair of brake bars 43 in series and the other end thereof is connected to the auxiliary actuator 50, and either brake disc 60 (or 61) is extended through one pair of brakes 41 (or another pair of brakes 41) in series. Also, any brake bar 43 and thus the associated brake 41 can be deactivated by controlling the auxiliary actuator 50.

Referring to FIG. 5, a brake system according to a fourth preferred embodiment of the elevator escape device is characterized in that each of four links 51 is interconnected one of the brake bars 43 and the auxiliary actuator 50 (i.e., parallel connection), and either brake disc 60 (or 61) is extended through one pair of brakes 41 (or another pair of brakes 41) in series. Also, any brake bar 43 and thus the associated brake 41 can be deactivated by controlling the auxiliary actuator 50.

The detector 42 is able to detect any malfunctioned brake 41 and inform the auxiliary actuator 50 to deactivate the brake bar 43 associated with the malfunctioned brake 41 by activating the associated link 51. Thus, the malfunctioned brake 41 can be known so as to be repaired thereafter. Also, a normal operation of the elevator can still be effected when the brake 41 is malfunctioned.

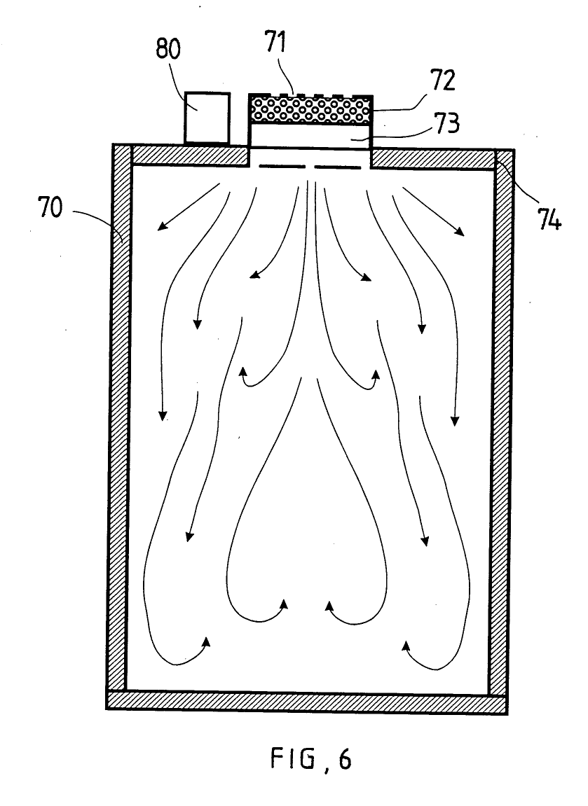

Referring to FIG. 6, a ventilation arrangement of the elevator escape device comprises a filter 72 is provided in an air inlet 71 at roof of a car 70. A blower 73 is also provided in the air inlet 71. In case of fire, smoke can be filtered by the filter 72. Also, the blower 73 is activated to blow the filtered air into the car 70. Thus, pressurized fresh air is always drawn into the car 70 for supplying to person(s) trapped in the car 70 with a portion of the air leaving the car 70 through gaps 74. The blower 73 is energized by a backup power supply 80 on top of the car 70.

While the invention herein disclosed has been described by means of specific embodiments, numerous modifications and variations could be made thereto by those skilled in the art without departing from the scope and spirit of the invention set forth in the claims.

What is claimed is:

1. An escape device of an elevator comprising a car, a motor including normal coils, a sheave driven by the motor, hoist ropes run in a grooved rim of the sheave, the hoist ropes having one end connected to the car, a counterweight connected to the other end of the hoist ropes, a backup power supply for activating the motor, a brake disposed between the sheave and the motor, and a slow movement assembly including:
a brake bar disposed on a top of the brake;
a fixed roller;
a rope having one end fixedly connected to the brake bar and the other end extended down onto a wall of the car by running in the roller; and
a pair of electromagnetic contact and electromagnetic actuator disposed between the brake bar and the roller,
wherein in case of power outage a person trapped in the car can pull the rope or activate the backup generator by means of a remote control for enabling the electromagnetic actuator so as to close the electromagnetic contact and disable the brake, and the sheave slowly rotates in response to a height difference between the counterweight and the car.

2. An escape device of an elevator having a car, the escape device comprising a ventilation system including:
an air inlet disposed on a roof of the car;
a filter disposed in the air inlet; and
a blower disposed in the air inlet,
wherein in case of fire, smoke is filtered by the filter, and the blower is activated to blow filtered air into the car.

3. The escape device of claim 2, further comprising a backup power supply for energizing the blower in case of fire.
